(19) United States
(12) Patent Application Publication
(10) Pub. No.: US 2025/0131364 A1
(43) Pub. Date: Apr. 24, 2025

(54) METHODS FOR GENERATING INSIGHT DATA AND RECOMMENDATIONS FROM ANALYTICAL DATA AND DEVICES THEREOF

(71) Applicant: Jones Lang LaSalle IP, Inc., Chicago, IL (US)

(72) Inventors: Dan STARK, Chandler, AZ (US); Jack CUTHBERT, New Lenox, IL (US); Jeremy ARENDT, East Dundee, IL (US); Jason MAY, Nashville, TN (US)

(21) Appl. No.: 18/381,476

(22) Filed: Oct. 18, 2023

(51) Int. Cl. G06Q 10/0639; G06F 9/451

(52) U.S. Cl. CPC G06Q 10/06393; G06F 9/451

(57) ABSTRACT

Methods, non-transitory computer readable media, analytics apparatuses, and systems includes identifying, by a computing apparatus, one or more of a plurality of stored dashboards based on a selection from available metrics and contextual data in a received data processing request from a client device. Dashboard configuration data associated with the identified ones of the plurality of stored dashboards can be retrieved based on the selection from the available metrics and the contextual data. Manipulated data can be generated from the dashboard configuration data based on the contextual data. The manipulated data can be filtered based on one or more selected filters received from the client device. The filtered manipulated data can be analyzed to generate a set of insight data. A new dashboard based on the generated set of insight data can be outputted as a response to the data processing request.

### FIELD

This technology relates to methods and systems for generating insight data and recommendations from analytical data.

### BACKGROUND

Traditional graphical user interface dashboards are each designed to provide a user with a particularly arranged view of key indicators. These dashboards can exist within the same and/or different systems and can take a variety of different formats with emphasis on different metrics and data depending on the particular developer.

Although these graphical user interface dashboards are helpful, one of the technological problems with these dashboards is the lack of any effective mechanism to dynamically identify insight data. As a result, a user typically must manually go through several different dashboards to try and find metrics related to desired insight data and then collate and analyze this often incomplete metric and insight data to identify any issues.

Further, under once an insight or problem is identified, another technological problem is the current inability to track progress or implement execution of any necessary actions against the identified issue. Currently there are no tools or other mechanisms that enable this type of implementation.

### SUMMARY

A method for generating insight data and recommendations from analytical data, includes identifying, by a computing apparatus, one or more of a plurality of stored dashboards based on a selection from available metrics and contextual data in a received data processing request from a client device. Dashboard configuration data associated with the identified ones of the plurality of stored dashboards can be retrieved based on the selection from the available metrics and the contextual data. Manipulated data can be generated from the dashboard configuration data based on the contextual data. The manipulated data can be filtered based on one or more selected filters received from the client device. The filtered manipulated data can be analyzed to generate a set of insight data. A new dashboard based on the generated set of insight data can be outputted as a response to the data processing request.

An analytics apparatus including memory including programmed instructions stored thereon and one or more processors configured to be capable of executing the stored programmed instructions to identify, by a computing apparatus, one or more of a plurality of stored dashboards based on a selection from available metrics and contextual data in a received data processing request from a client device. Dashboard configuration data associated with the identified ones of the plurality of stored dashboards can be retrieved based on the selection from the available metrics and the contextual data. Manipulated data can be generated from the dashboard configuration data based on the contextual data. The manipulated data can be filtered based on one or more selected filters received from the client device. The filtered manipulated data can be analyzed to generate a set of insight data. A new dashboard based on the generated set of insight data can be outputted as a response to the data processing request.

A non-transitory computer readable medium having stored thereon instructions for including executable code that, when executed by one or more processors, causes the processors to identify, by a computing apparatus, one or more of a plurality of stored dashboards based on a selection from available metrics and contextual data in a received data processing request from a client device. Dashboard configuration data associated with the identified ones of the plurality of stored dashboards can be retrieved based on the selection from the available metrics and the contextual data. Manipulated data can be generated from the dashboard configuration data based on the contextual data. The manipulated data can be filtered based on one or more selected filters received from the client device. The filtered manipulated data can be analyzed to generate a set of insight data. A new dashboard based on the generated set of insight data can be outputted as a response to the data processing request.

Examples of this technology provide a number of advantages including providing methods, non-transitory computer readable media, and analytics apparatuses that generates a insight data and recommendations from analytical data in a customized dashboard that provides easy tracking for users. With examples of this technology, dashboards and the related data which are related to a received request can be more quickly and effectively be analyzed and identified for the generation of a customized dashboard. Further, examples of this technology can also identify, track, and analyze ongoing data related to the new dashboard for progress for any identified issue or problem. Even further, examples of this technology provide an automated mechanism to generate and provide insight data and recommendations addressing any identified issue or problem.

### BRIEF DESCRIPTION OF THE DRAWINGS

FIG. 1 is a block diagram of a network environment that includes an example of an analytics apparatus configured to generate a new dashboard based on insight data and recommendations from analytical data;

FIG. 2 is a screenshot of an example interface with a listing of available metrics and a search feature configured to allow a user to filter the available metrics;

FIG. 3 is a screenshot of an example interface allowing the selection from available metrics;

FIG. 4 is a screenshot of an example interface allowing the selection of available contexts;

FIG. 5 is a screenshot of an example interface allowing the selection of a filter;

FIG. 6 is a screenshot of an example interface with an exemplary monitored, pinned metric;

FIG. 7 is a screenshot of an example interface with an exemplary monitored, pinned metric after a time period has passed;

FIG. 8 is a screenshot of an example interface with an exemplary expanded pinned metric;

FIG. 9 is a screenshot of an example interface with an exemplary monitored, pinned metric and a pinned new dashboard based on a generated insight data;

FIG. 10 is a screenshot of an example interface with an exemplary monitored, pinned metric and a pinned new dashboard based on a generated insight data after a time period has passed;

FIG. 11 is a screenshot of an example interface with an exemplary expanded pinned metric after a time period has passed;

FIG. 12 is a screenshot of an example interface with an exemplary monitored, pinned metric and a pinned new dashboard based on a generated insight data, the new dashboard including an icon indicating an available success story;

FIG. 13 is a screenshot of an example interface with success stories with a new dashboard, a list of completed recommended actions, and insight data.

FIG. 14 is a screenshot of an example interface with new dashboards based on a set of generated insight data;

FIG. 15 is a screenshot of an example interface with an expanded dashboard based on generated insight data without recommended actions;

FIG. 16 is a screenshot of an example interface with an expanded dashboard based on generated insight data with a recommended action;

FIG. 17 is a screenshot of an example interface with an expanded dashboard based on generated insight data with a completed recommended action;

FIG. 18 is a screenshot of an example interface with new dashboards based on a set of generated insight data;

FIG. 19 is a screenshot of an example interface with new dashboards based on a set of generated insight data;

FIG. 20 is a flowchart of an exemplary method for generating insight data and recommendations.

### DETAILED DESCRIPTION

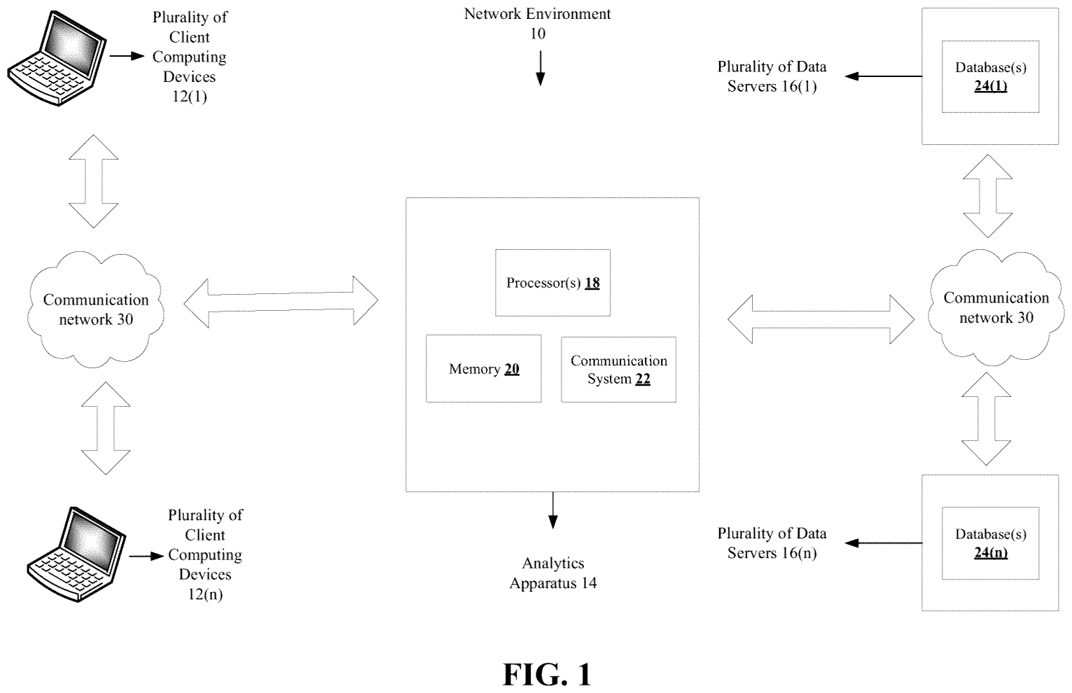

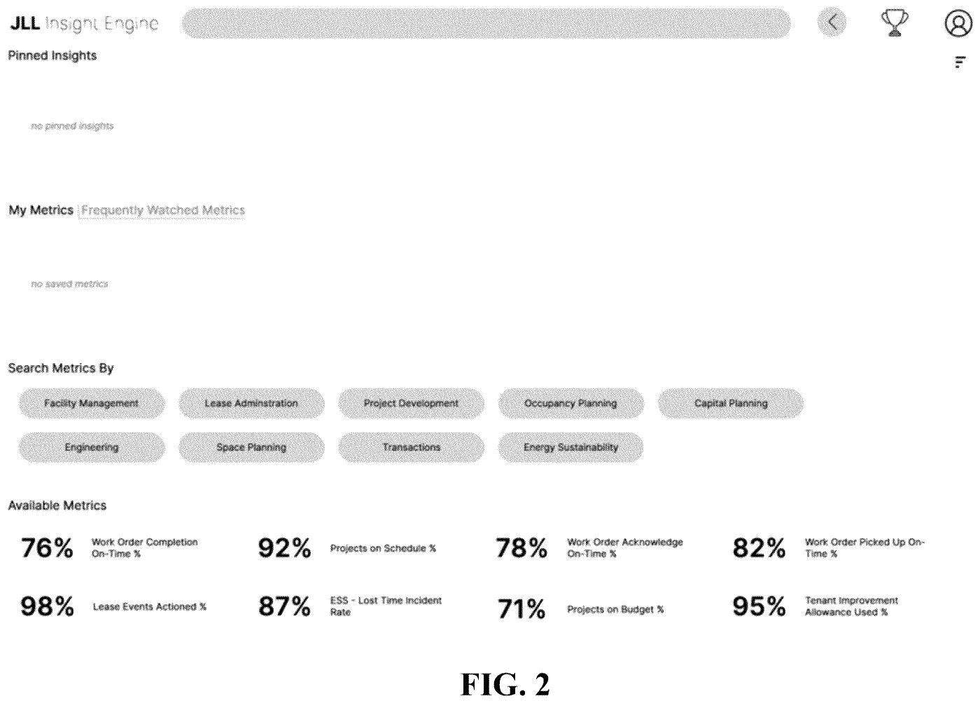

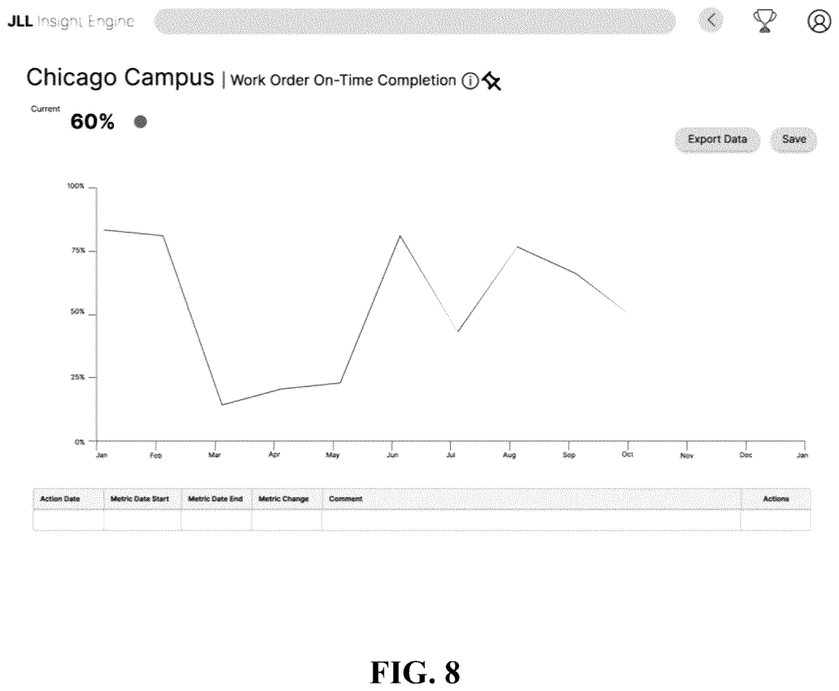

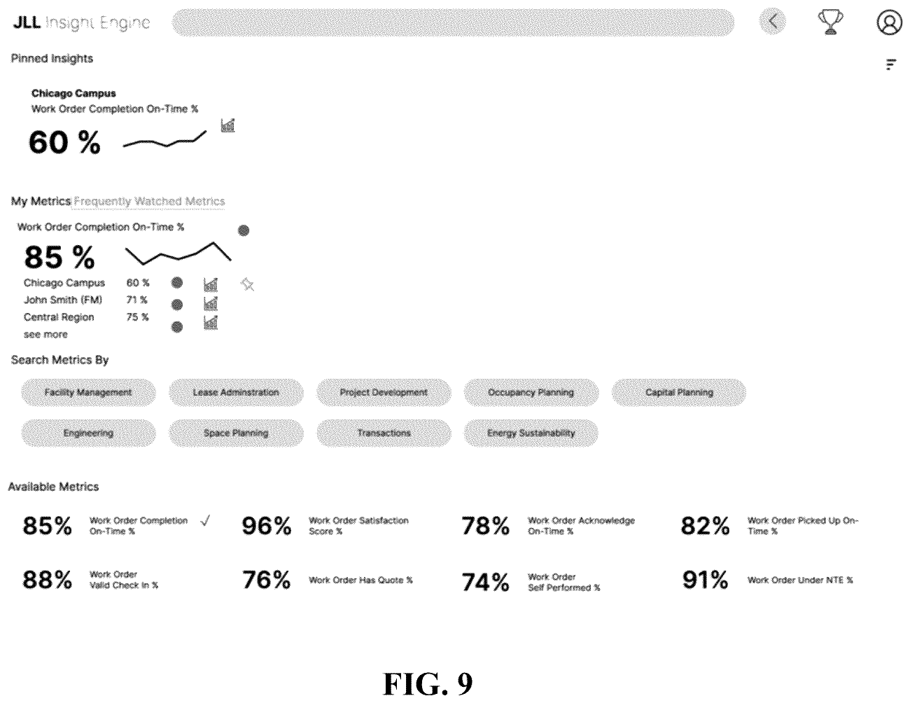

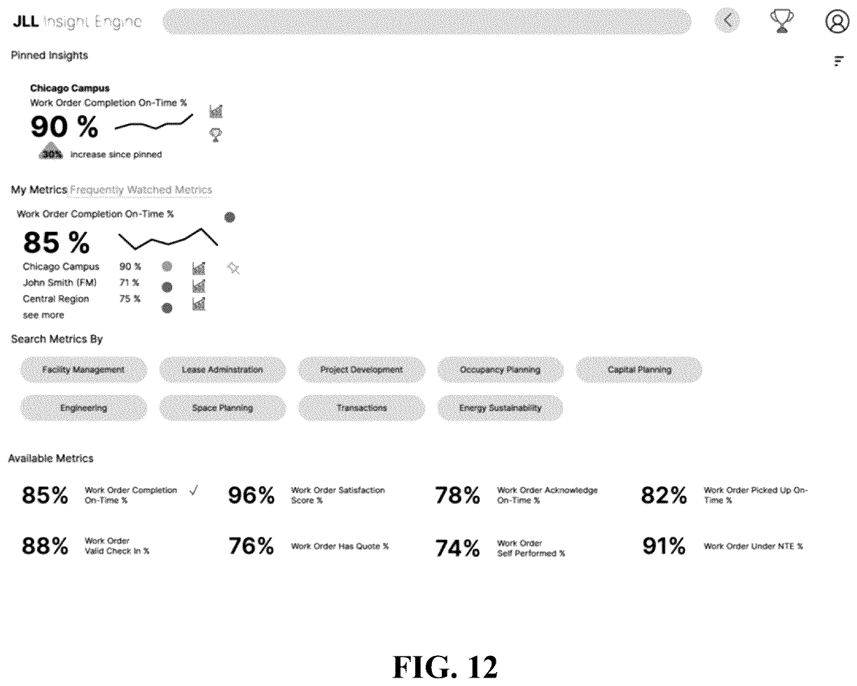

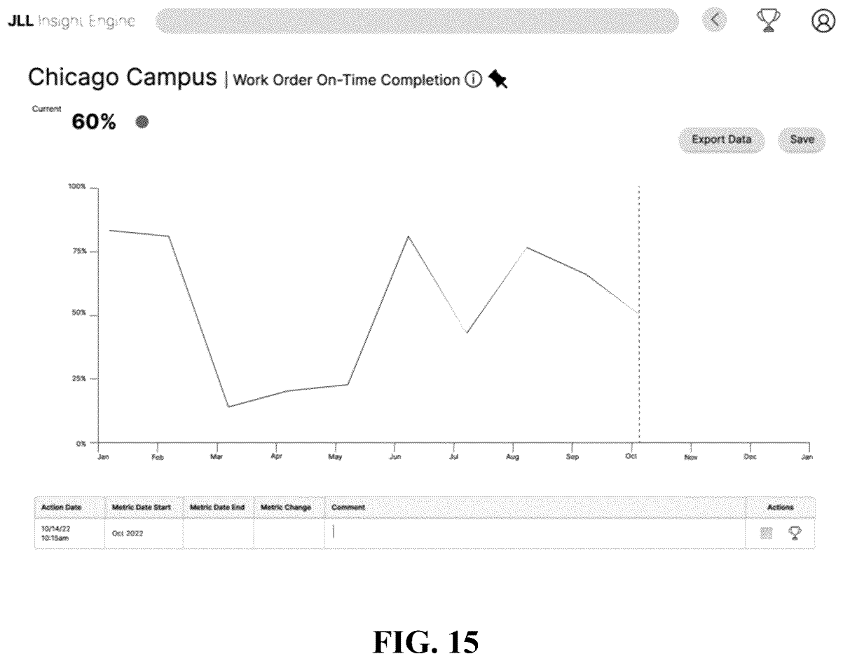

An example of the proposed technology includes an exemplary network environment 10 which incorporates an exemplary environment 10 with an analytics apparatus 14 is illustrated in FIG. 1. The exemplary environment 10 includes a plurality of client computing devices 12(1)-12(n), an analytics apparatus 14, the analytics apparatus 14, and the plurality of data server(s) 16(1)-16(n) which are coupled together by communication networks 30, although the environment can include other types and numbers of systems, devices, components, and/or elements and in other topologies and deployments. While not shown, the exemplary environment 10 may include additional network components, such as routers, switches, and other devices, which are well known to those of ordinary skill in the art and thus will not be described here. In some examples, the analytics apparatus 14 includes a user interface that interacts with the plurality of client computing devices 12(1)-12(n) and provides selectable metrics, context data, and filters in one place as illustrated in FIGS. 2-19. New dashboards with recommended actions and generated insights can be pinned and easily tracked. This technology provides a number of advantages including providing methods, non-transitory computer readable medium, and apparatuses that accurately and cost effectively assess and identify in real time insights or recommendations from analytical data.

Referring more specifically to FIG. 1, the analytics apparatus 14 of the exemplary environment 10 is coupled to the plurality of client computing devices 12(1)-12(n) through the communication network 30, although the plurality of client computing devices 12(1)-12(n) and analytics apparatus 14 may be coupled together via other topologies. Additionally, the analytics apparatus 14 is coupled to the analytics apparatus 14 through the communication network 30, although the analytics apparatus 14 and the analytics apparatus 14 may be coupled together via other topologies.

The analytics apparatus 14 includes processor(s) 18 or central processing unit (CPU), memory 20, optional configurable hardware logic, and a communication system 22 which are coupled together by a bus device although the analytics apparatus 14 may comprise other types and numbers of elements in other configurations. In this example, the bus is a PCI Express bus in this example, although other bus types and links may be used. The analytics apparatus 14 can include a communication system 22 used to convey information, such as computer-executable instructions or other data. As a specific example, a communication system 22 of the analytics apparatus 14 operatively couples to and communicates with the communication network 30 so that the analytics apparatus 14 is coupled to and can communicate with the client computing devices 12(1)-12(n) and the plurality of data servers 16(1)-16(n).

The analytics apparatus 14 assists with providing insights and recommendations from the analytical data as illustrated and described by way of the examples herein, although the analytics apparatus 14 may perform other types and/or numbers of functions. The processors 18 within the analytics apparatus 14 may execute one or more computer-executable instructions stored in memory 20 for the methods illustrated and described with reference to the examples herein, although the processor can execute other types and numbers of instructions and perform other types and numbers of operations. The processor 18 may comprise one or more central processing units (“CPUs”) or general-purpose processors with one or more processing cores, such as AMD® processor(s), although other types of processor(s) could be used (e.g., Intel®).

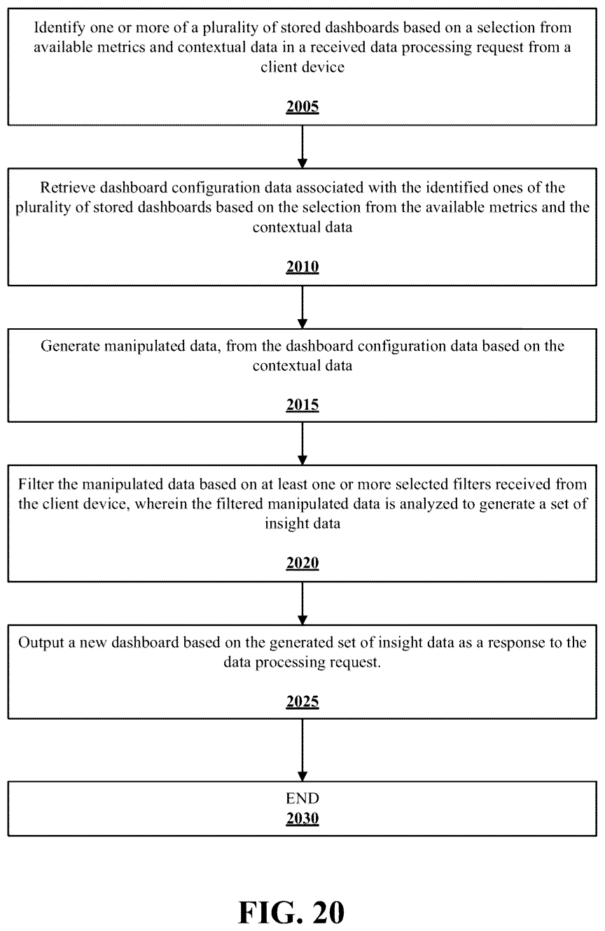

The memory 20 within the analytics apparatus 14 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. The memory 20 may store one or more non-transitory computer-readable instructions of this technology as illustrated and described with reference to the examples herein that may be executed by the processor 18. The exemplary flowchart shown in FIG. 20 is representative of example steps or actions of this technology that may be embodied or expressed as one or more non-transitory computer or machine-readable instructions stored in the memory 20 that may be executed by the processor 18 and/or may be implemented by configured logic.

In some examples, the memory 20 can also include a plurality of stored dashboards. Each of the plurality of stored dashboards can have corresponding dashboard configuration data also stored in the memory 20. The dashboard configuration data can be either structured and/or unstructured data. The plurality of stored dashboards or the corresponding dashboard configuration data can be received from the client computing devices 12(1)-12(n) or can be retrieved from any of a plurality of databases 24(1)-24 (n). The plurality of databases 24(1)-24 (n) can be stored in the memory 20 or accessed via the plurality of data servers 16(1)-16(n). In this particular example, the dashboard configuration data that is stored, obtained, or retrieved may include: employee data, transactions data, engagement and experience data; workplace data comprising properties and facilities data, workspaces and stations data, and facility management data; interact data comprising digital assistants data and collaboration platform metadata; and/or other data comprising external source data. The memory 20 can include any kind of data that can be structured and/or unstructured that can be analyzed for insights or recommendations.

Accordingly, the memory 20 of the analytics apparatus 14 can store one or more applications that can include computer executable instructions that, when executed by the analytics apparatus 14, causes the analytics apparatus 14 to perform actions, such as to transmit, receive, or otherwise process messages, for example, and to perform other actions described and illustrated below with reference to FIGS. 2-20. The application(s) can be implemented as module or components of another application. Further, the application(s) can be implemented as operating system extensions, module, plugins, or the like. The application(s) can be implemented as module or components of another application. Further, the application(s) can be implemented as operating system extensions, module, plugins, or the like. Even further, the application(s) may be operative in a cloud-based computing environment. The application(s) can be executed within virtual machine(s) or virtual server(s) that may be managed in a cloud-based computing environment. Also, the application(s), including the analytics apparatus 14 itself, may be located in virtual server(s) running in a cloud-based computing environment rather than being tied to one or more specific physical network computing devices. Also, the application(s) may be running in one or more virtual machines (VMs) executing on the analytics apparatus 14. Additionally, in at least one of the various examples, virtual machine(s) running on the analytics apparatus 14 may be managed or supervised by a hypervisor. Additionally, one or more of the components that together comprise the analytics apparatus 14 can be standalone devices or integrated with one or more other devices or apparatuses, such as with a plurality of servers, for example.

The communication system 22 in the analytics apparatus 14 is used to operatively couple and communicate between the analytics apparatus 14, the plurality of client computing devices 12(1)-12(n), and the analytics apparatus 14 which are all coupled together by communication network 30. By way of example only, the communication network can be the internet or another public network. By way of example only, the communication system 22 can use TCP/IP over Ethernet and industry-standard protocols, including NFS, CIFS, SOAP, XML, LDAP, SCSI, and SNMP, although other types and numbers of communication networks, can be used. The communication system 22 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

Each of the plurality of client computing devices 12(1)-12(n) of the exemplary environment 10, include a central processing unit (CPU) or processor, a memory, input/display device interface, configurable logic device and an input/output system or I/O system, which are coupled together by a bus or other link. Additionally, the plurality of client computing devices 12(1)-12(n) can include any type of computing device that can receive, render, and facilitate user interaction, such as client computers, network computer, mobile computers, mobile phones, virtual machines (including cloud-based computer), or the like. Each of the plurality of client computing devices 12(1)-12(n) utilizes the analytics apparatus 14 to conduct one or more operations with the analytics apparatus 14, such as communicating with the plurality of data server(s) 16(1)-16(n) via a communication network 30 between the analytics apparatus 14 and the plurality of data server(s) 16(1)-16(n), by way of example only, although other functions could also be performed as well. In this particular example, each of plurality of client computing devices 12(1)-12(n) can may send a request to for insight data relating an identified problem. The analytics apparatus 14 can receive requests that are transmitted by the plurality of client computing devices 12(1)-12(n) using a communication network 30.

Generally, the plurality of data server(s) 16(1)-16(n) can perform various computing tasks that are implemented using a computing environment. The computing environment can include computer hardware, computer software, and combinations thereof. As a specific example, the computing environment can include general-purpose and/or special-purpose processor(s), configurable and/or hard-wired electronic circuitry, a communications interface, and computer-readable memory for storing computer-executable instructions to enable the processor(s) to perform a given computing task. The logic to perform a given task can be specified within a single module or interspersed among multiple modules. As used herein, the terms “module” and “component” can refer to an implementation within one or more dedicated hardware devices or apparatus (e.g., computer(s)), and/or an implementation within software hosted by one or more hardware devices or apparatus that may be hosting one or more other software applications or implementations.

The plurality of data server(s) 16(1)-16(n) can be implemented using various different computer architectures. For example, a plurality of data server(s) 16(1)-16(n) can be implemented as a plug-in circuit card that interfaces to an input/output or peripheral interface (such as Peripheral Component Interconnect Express (PCIe)) of a computer and can include a connector for connecting to a backplane or other connector of the computer. As another example, a plurality of data server(s) 16(1)-16(n) can be implemented as a computer appliance that is connected over a computer network (a network-based plurality of data server(s) 16(1)-16(n)). As another example, a plurality of data server(s) 16(1)-16(n) can be implemented as a virtualized resource within a cloud-computing infrastructure (a cloud-based plurality of data server(s) 16(1)-16(n)). The plurality of data server(s) 16(1)-16(n) can have different storage capacities and/or acceleration capabilities. For example, a physical plurality of data server(s) 16(1)-16(n) can be divided into multiple logical plurality of data server(s) 16(1)-16(n), where each logical plurality of data server(s) 16(1)-16(n) can have different capabilities and can be accessed using different account credentials. A plurality of data server(s) 16(1)-16(n) can use various storage technologies, such as random-access memory (RAM), non-volatile RAM, FLASH memory, a hard-disk drive, a solid-state drive, or other storage implementations. The storages of the plurality of data server(s) 16(1)-16(n) can also include a plurality of stored dashboards. Each of the plurality of stored dashboards can have corresponding dashboard configuration data also stored in the storages of the plurality of data server(s) 16(1)-16(n). The dashboard configuration data can be either structured and/or unstructured data. In this particular example, the dashboard configuration data that can be stored in the storages of the plurality of data server(s) 16(1)-16(n) may include: employee data, transactions data, engagement and experience data; workplace data comprising properties and facilities data, workspaces and stations data, and facility management data; interact data comprising digital assistants data and collaboration platform metadata; and/or other data comprising external source data. The storages of the plurality of data server(s) 16(1)-16(n) can include any kind of data that can be structured and/or unstructured that can be analyzed for insights or recommendations.

In one example, the analytics apparatus 14 can be a dedicated computing device including a processor 18 and a computer-readable memory 20. The memory 20 of the analytics apparatus 14 can store one or more applications that can include computer-executable instructions that, when executed by the analytics apparatus 14, cause the analytics apparatus 14 to perform actions, such as to transmit, receive, or otherwise process messages. The application(s) can be implemented as components of other applications. Further, the application(s) can be implemented as operating system extensions, plugins, or the like.

Thus, the technology disclosed herein is not to be construed as being limited to a single environment and other configurations and architectures are also envisaged. For example, the plurality of data server(s) 16(1)-16(n) depicted in FIG. 1 can operate within analytics apparatus 14 rather than as a stand-alone server communicating with analytics apparatus 14 via the communication network(s) 30. In this example the plurality of data server(s) 16(1)-16(n) operates within the memory 20 of the analytics apparatus 14.

While the analytics apparatus 14 is illustrated in this example as including a single device, the analytics apparatus 14 in other examples can include a plurality of devices or blades each with processors each processor with one or more processing cores that implement one or more steps of this technology. In these examples, one or more of the devices can have a dedicated communication interface or memory. Alternatively, one or more of the devices can utilize the memory, communication interface, or other hardware or software components of one or more other communicably coupled of the devices. Additionally, one or more of the devices that together comprise analytics apparatus 14 in other examples can be standalone devices or integrated with one or more other devices or applications, plurality of data servers 16(1)-16(n) or, the analytics apparatus 14, or the analytics apparatus 14, or applications coupled to the communication network(s), for example. Moreover, one or more of the devices of the analytics apparatus 14 in these examples can be in a same or a different communication network 30 including one or more public, private, or cloud networks, for example.

Although an exemplary environment 10 with the plurality of client computing devices 12(1)-12(n), the analytics apparatus 14, the analytics apparatus 14, and the plurality of data server(s) 16(1)-16(n), and communication networks 30 are described and illustrated herein, it is to be understood that the systems of the examples described herein are for exemplary purposes, as many variations of the specific hardware and software used to implement the examples are possible, as will be appreciated by those skilled in the relevant art(s).

Further, each of the systems of the examples may be conveniently implemented using one or more general purpose computer systems, microprocessors, digital signal processors, and micro-controllers, programmed according to the teachings of the examples, as described, and illustrated herein, and as will be appreciated by those of ordinary skill in the art.

One or more of the components depicted in the exemplary environment 10, such as the analytics apparatus 14, the plurality of client computing devices 12(1)-12(n), the analytics apparatus 14, and the plurality of data server(s) 16(1)-16(n), for example, may be configured to operate as virtual instances on the same physical machine. In other words, one or more of analytics apparatus 14, the plurality of client computing devices 12(1)-12(n), the analytics apparatus 14, or the plurality of data server(s) 16(1)-16(n) illustrated in FIG. 1 may operate on the same physical device rather than as separate devices communicating through a network as depicted in FIG. 1. There may be more or fewer plurality of client computing devices 12(1)-12(n), analytics apparatus 14, the analytics apparatus 14, or the plurality of data server(s) 16(1)-16(n) than depicted in FIG. 1. The plurality of client computing devices 12(1)-12(n), the analytics apparatus 14, the plurality of data servers 16(1)-16(n) could be implemented as applications on analytics apparatus 14.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

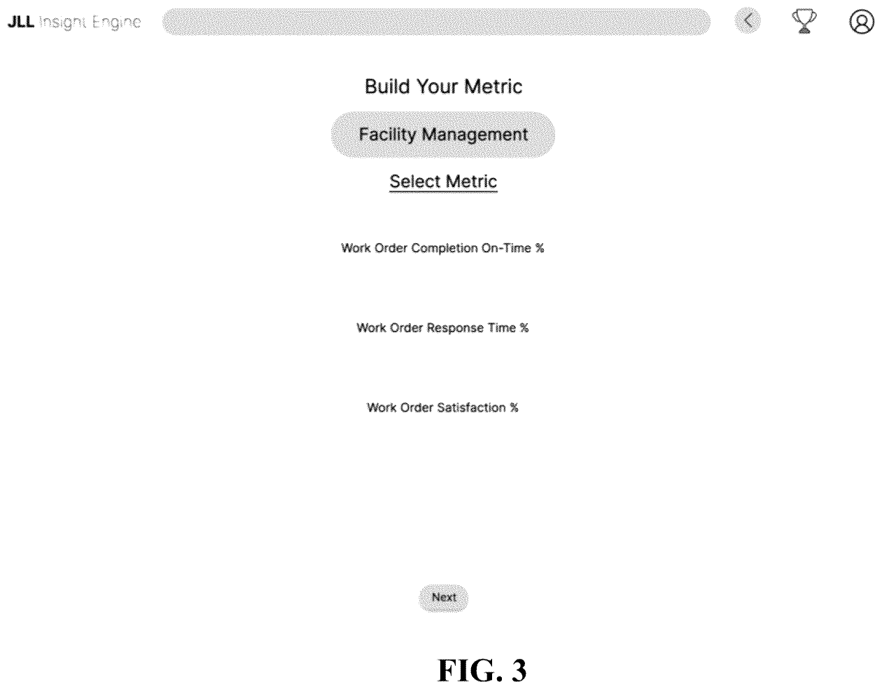

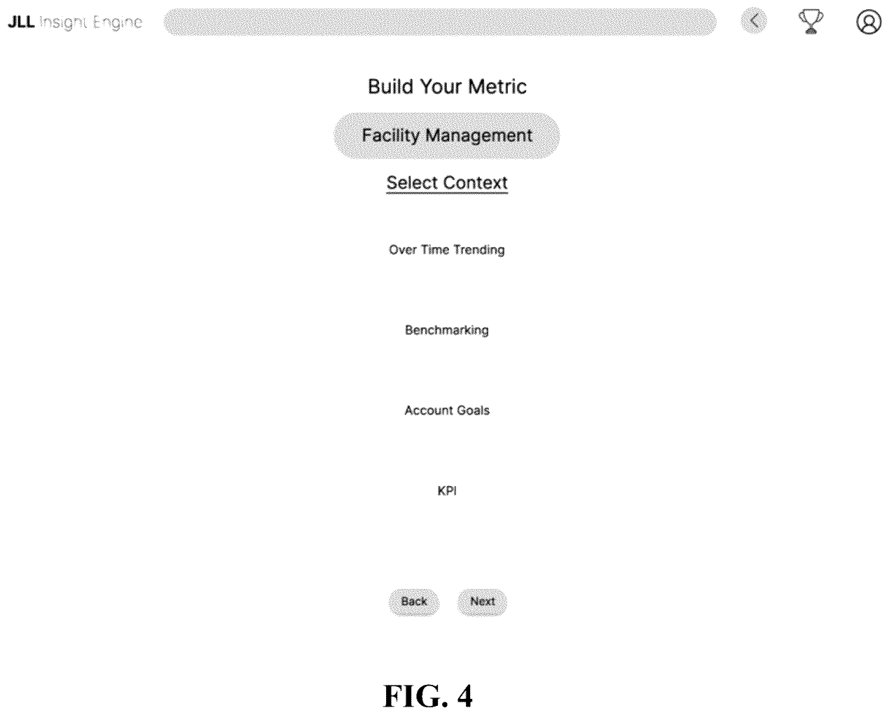

An example of a method for generating insight data and recommendations from analytical data will now be described with reference to FIGS. 1-20. First in step 2005, the analytics apparatus 14 can identify one or more of a plurality of stored dashboards based on a selection from available metrics and contextual data in a received data processing request from a requesting one of the plurality of client computing devices 12(1)-12(n). In this particular example, the requesting one of the client computing devices 12(1)-12(n) can send the data processing request to the analytics apparatus 14 by interacting with a graphical user interface of the analytics apparatus 14. The analytics apparatus 14 can generate the interface for display with the available metrics and contextual data and transmit the interface to the requesting one of the client computing devices 12(1)-12(n) as illustrated in FIGS. 3 and 4.

The requesting one of the client computing devices 12(1)-12(n) can then select from the available metrics and contextual data to send to the analytics apparatus 14. In this particular example, the available metrics can include facilities management metrics, finance metrics, project metrics, occupancy metrics, lease administration metrics, energy metrics, and health safety environment metrics, although other types metrics in other combinations may be used. The facilities management metrics can further include a percentage of work completing on time metric, a percentage of acknowledgements of work completing on time metric, a reactive spending budget metric, preventive spending budget metric, emergency work orders metric, customer satisfaction metrics, and vendor metrics (e.g., vendors spending above average metrics). The project metrics can include off schedule metrics and over budget metrics. The energy metrics can include by way of example only greenhouse gas metrics and refrigerant metrics. The type of metrics can be customized depending on the industry using the proposed technology. A person skilled in the art knows that this metric can be customized for a particular client to measure what the particular client wants to target.

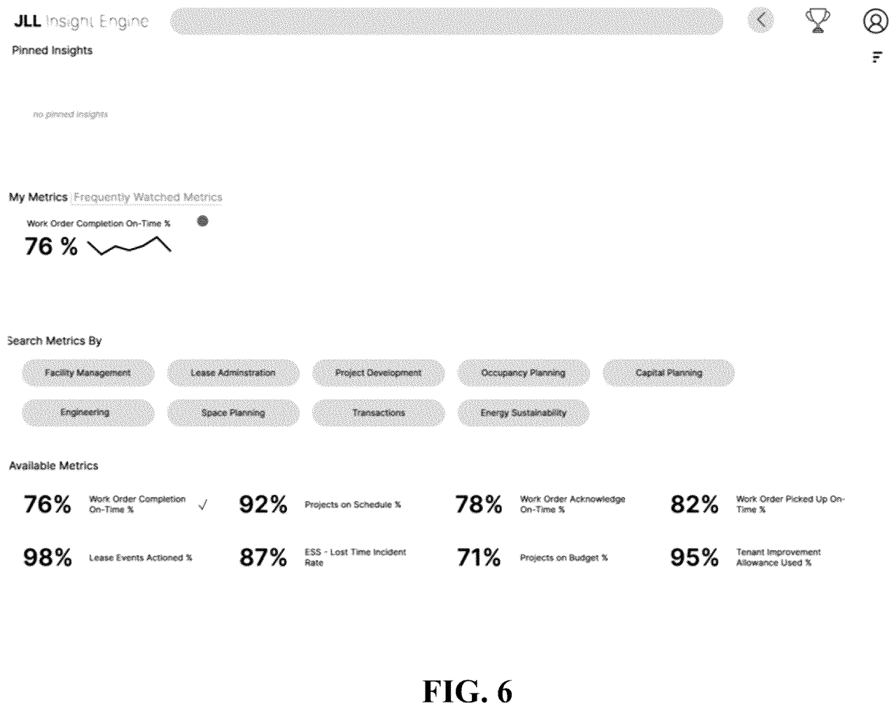

After the requesting one of the client computing devices 12(1)-12(n) selects a metric from the available metrics, the analytics apparatus 14 can then identify one or more of the plurality of stored dashboards that are associated with the selected available metric. For this particular example, as illustrated in FIG. 6, the selected available metric can be a percentage of work orders completed on time. The analytics apparatus 14 can then identify the one or more of the plurality of stored dashboards that are associated with work orders. The analytics apparatus 14 can have a mapping between the plurality of stored dashboards and the available metrics. When an available metric is selected, the analytics apparatus 14 can identify the plurality of stored dashboards mapped to the selected available metric as the one or more of the plurality of stored dashboards.

In other examples, the analytics apparatus 14 can use a machine learning model to identify the one or more of the plurality of stored dashboards associated with the selected available metric. In this example, the analytics apparatus 14 can utilize a trained machine learning model to analyze each of the plurality of dashboards to determine which of the plurality of stored dashboards relate to the selected available metric. The machine learning model may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, or another machine learning model. Models may include an ensemble model (e.g., a model comprised of a plurality of models). The machine learning model may be trained using sample mappings between metrics and dashboards. In some examples, training of a model may terminate when a training criterion is satisfied although other manners for determining when training has reached an acceptable level or threshold may be used. Training criterion may include a number of epochs, a training time, a performance metric (e.g., an estimate of accuracy in reproducing test data), or the like. The analytics apparatus 14 may be configured to adjust model parameters during training to further optimize results. Model parameters may include weights, coefficients, offsets, or the like. Training may be supervised or unsupervised. The analytics apparatus 14 may be configured to train machine learning models by optimizing model parameters and/or hyperparameters (hyperparameter tuning) using an optimization technique, consistent with disclosed examples. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like.

In step 2010, the analytics apparatus 14 can retrieve dashboard configuration data associated with the identified ones of the plurality of stored dashboards based on the selection from the available metrics and the contextual data. Each of the plurality of stored dashboards can have associated dashboard configuration data in a structured or unstructured format or can be backed by a stored data structure with the dashboard configuration data. In this example, the identified ones of the plurality of stored dashboards can have associated dashboard configuration data relating to work orders. The dashboard configuration data can include a list of work orders with a status (e.g., open or closed), completion date (or projected completion date), scope, assigned employees, goals, or other characteristics of work orders known in the art.

In step 2015, the analytics apparatus 14 can generate manipulated data, from the dashboard configuration data based on the contextual data. As outlined above, the requesting one of the client computing devices 12(1)-12(n) could have selected the contextual data after selecting from the available metrics. The contextual data can include by way of example only a time period trend, a predetermined threshold, a predetermined goal, historical usage data, or a predetermined contractual obligation. The time period trend can include a selection of a set time period (e.g., 3 months, 6 months, 9 months, 1 year, etc.). The predetermined threshold can include retrieving benchmark data from one of the plurality of databases 24(1)-24 (n) stored in one or more of the plurality of servers 16(1)-16(n) and the analytics apparatus 14 determining the predetermined threshold based on the benchmark data. The predetermined goal, historical usage data, or predetermined contractual obligation can be retrieved from plurality of databases 24(1)-24 (n) stored in one or more of the plurality of servers 16(1)-16(n), received from the requesting one of the client computing devices 12(1)-12(n), or generated by the analytics apparatus 14.

In this example, the requesting one of the client computing devices 12(1)-12(n) could have selected the time period trend as the contextual data. The client device of the plurality of client devices 12(1)-12(n) can, for example, select a year for the set time period. The analytics apparatus 14 can then generate manipulated data comprising of work orders in the dashboard configuration data that are projected to be completed within the next year. The analytics apparatus 14 will then be able to follow the progress of the work orders in the manipulated data over the next year.

In another example, the requesting one of the client computing devices 12(1)-12(n) could have selected the predetermined threshold as the contextual data. The analytics apparatus 14 can then retrieve the benchmark data from one of the plurality of databases 24(1)-24 (n). The benchmark data can include an average time period for a work order to be completed in the industry (or an industry standard). In this example, the average time period can be seven months for a work order. The analytics apparatus 14 can then generate manipulated data comprising of work orders in the dashboard configuration data that are projected to be completed within the next seven months.

In another example, the requesting one of the client computing devices 12(1)-12(n) selects the predetermined goal, historical usage data, or predetermined contractual obligation as the contextual data. The predetermined goal can be to complete all work orders on time for the next year. There can also be a predetermined contractual obligation to complete the work orders over the next year. This predetermined goal or predetermined contractual obligation can result in the analytics apparatus 14 generating manipulated data comprising of work orders in the dashboard configuration data that are projected to be completed within the next year.

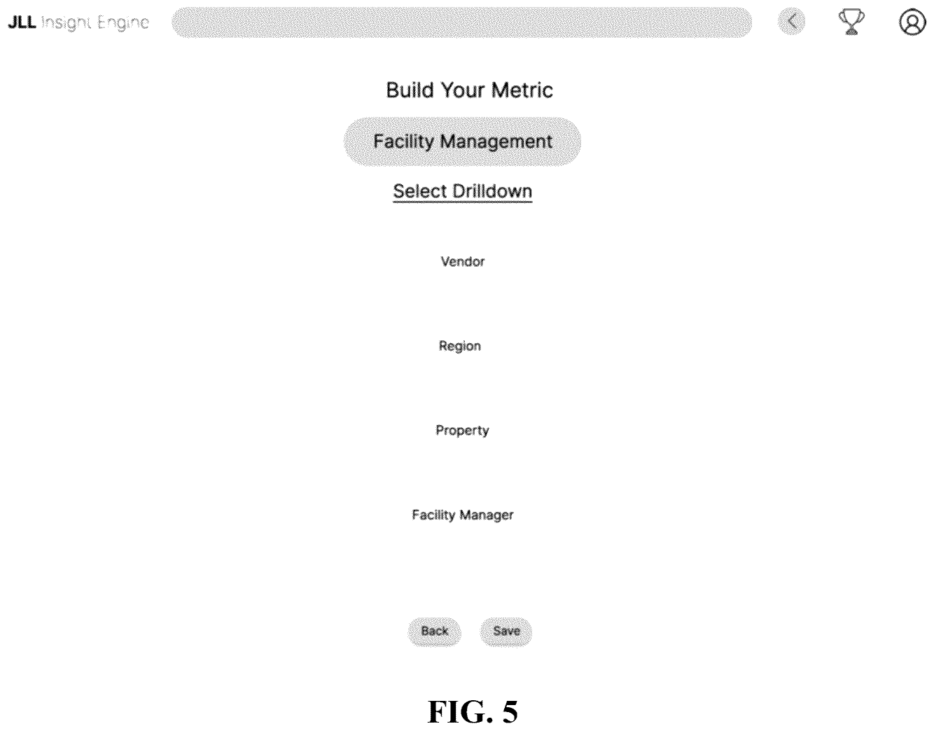

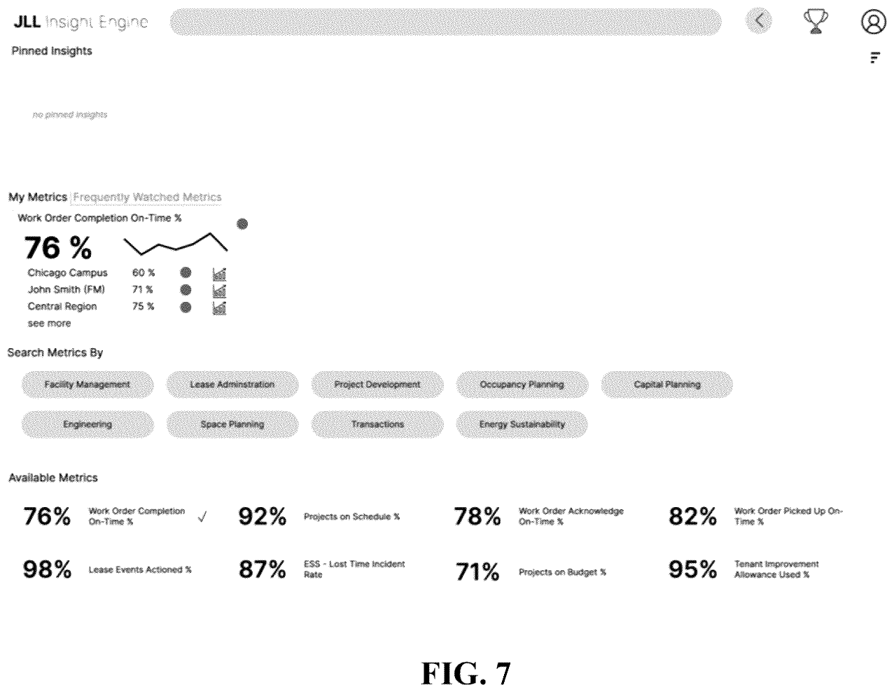

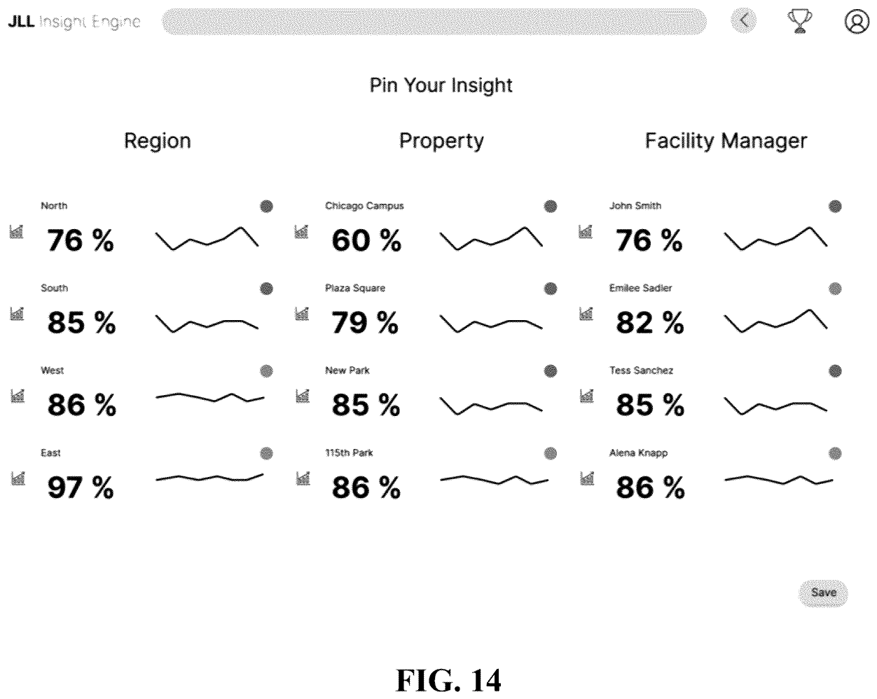

In this example, the requesting one of the client computing devices 12(1)-12(n) selected the time period trend as the contextual data and a year for the set time period to follow the progress of the work orders in the manipulated data over the next year. In step 2020, the analytics apparatus 14 can filter the manipulated data based on one or more selected filters received from the client device. The analytics apparatus 14 can modify the interface for display with available filters and transmit the interface to the requesting one of the client computing devices 12(1)-12(n) as illustrated in FIG. 5. The requesting one of the client computing devices 12(1)-12(n) can then select from the available filters to send to the analytics apparatus 14. In this particular example, the available filters can include a site filter, person filter, region filter, building type filter, or other filters known in the art. In this non-limiting example, the requesting one of the client computing devices 12(1)-12(n) can select the region filter as illustrated in FIGS. 7 and 14 (e.g., Chicago Campus, Central Region, etc.). The analytics apparatus 14 can then filter the manipulated data to separate the work orders according to predetermined regions. The filtered manipulated data would then include work orders projected to be completed within the next year, separated into the predetermined regions (Chicago Campus, Central Region, Mid Region, etc.).

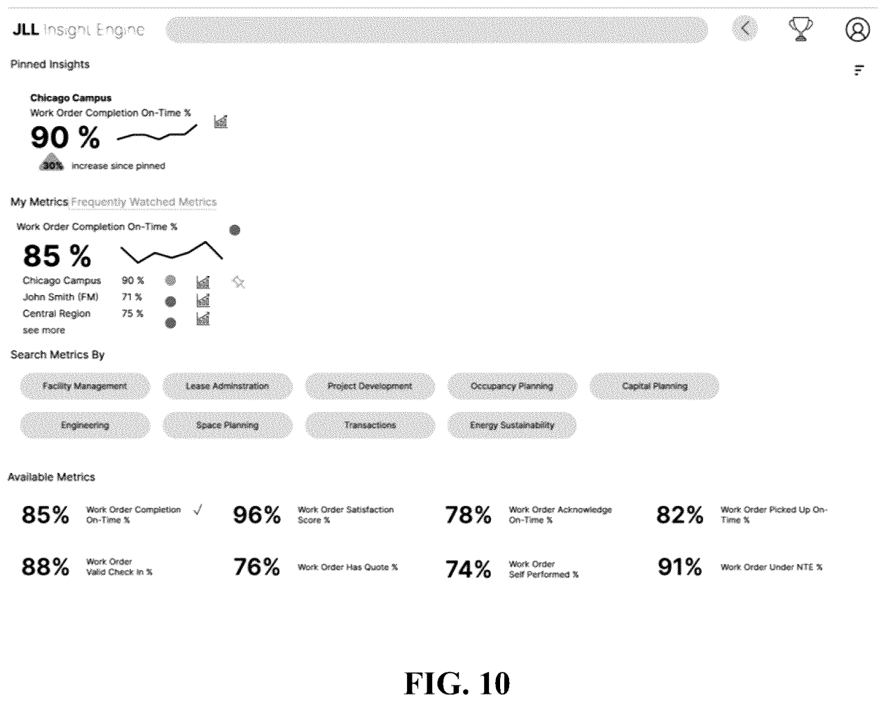

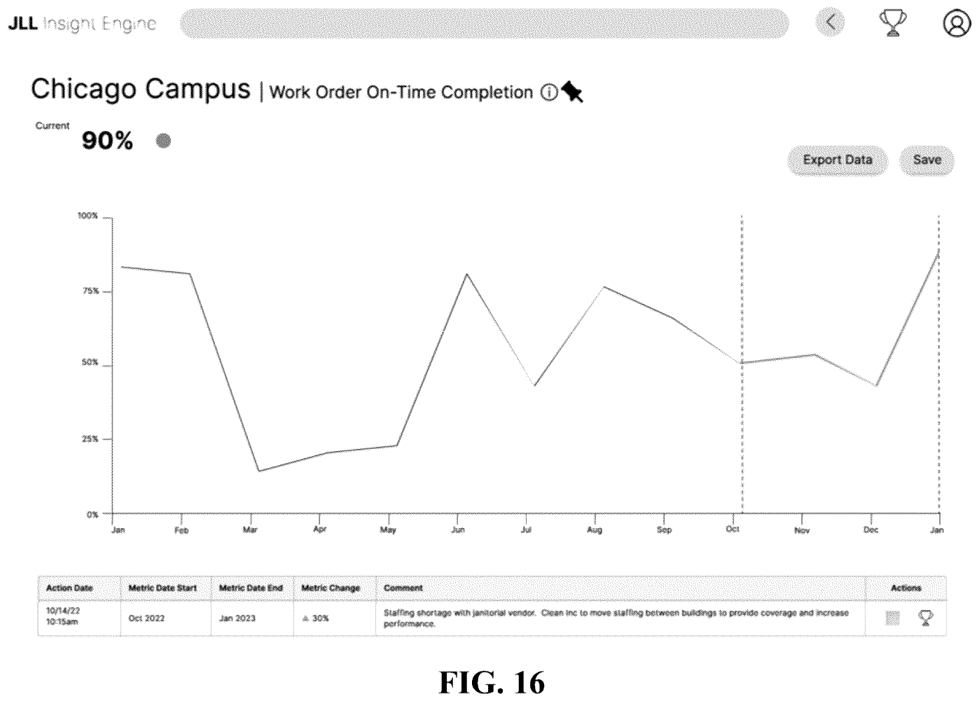

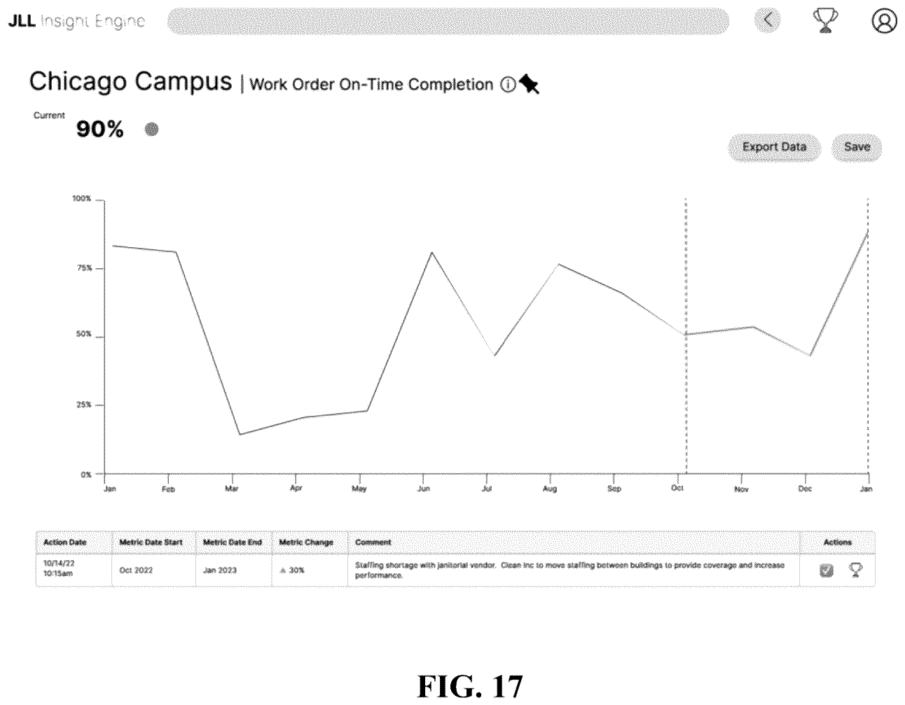

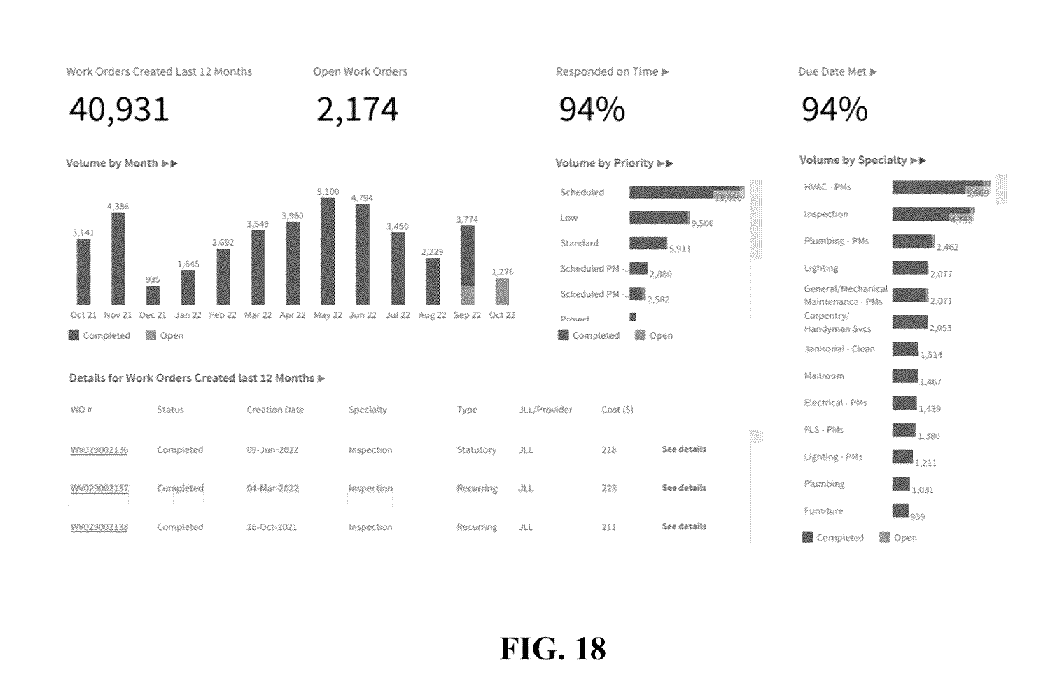

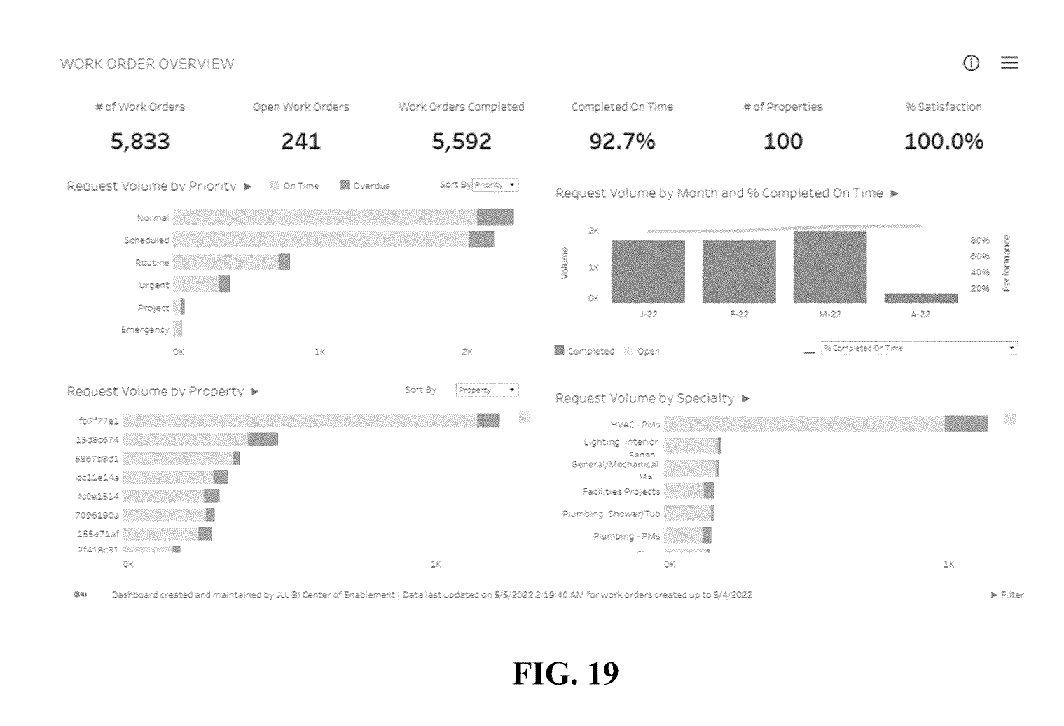

The analytics apparatus 14 can, after a period of time in this example (e.g., after 10 months as illustrated in FIG. 16 or after a year as illustrated in FIG. 17), analyze the filtered manipulated data to generate a set of insight data as illustrated in FIGS. 18 and 19. In some examples, the analytics apparatus 14 can generate the insight data using a machine learning model trained to identify the insight data or generate recommended actions related to a particular industry known in the art. In this non-limiting example, one year later, the analytics apparatus 14 can provide the set of insight data of which percentage of work orders were completed within the year period and which percentage of work orders were not completed on time as illustrated in FIGS. 10-13. As illustrated in FIG. 10, the set of insight data can include a percentage of work orders completed within one year at each of the predetermined regions (such as the Chicago Campus as illustrated under pinned insights in FIG. 10). A percentage of work orders with projected completion dates after the one year mark that were completed within the one year can be displayed as insight data as well (e.g., 30% increase of projected work orders illustrated in FIG. 10).

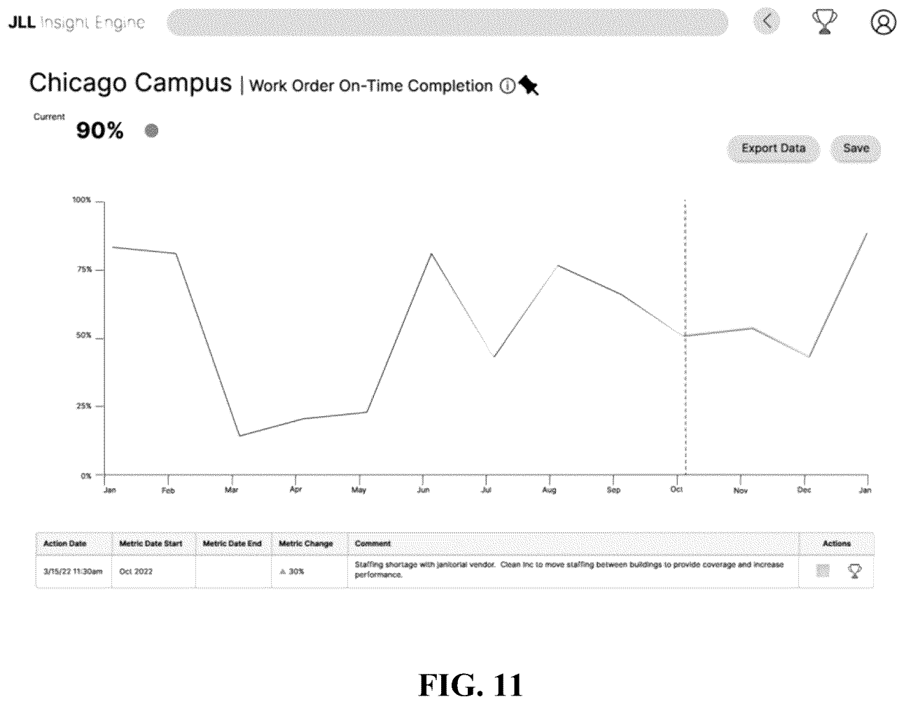

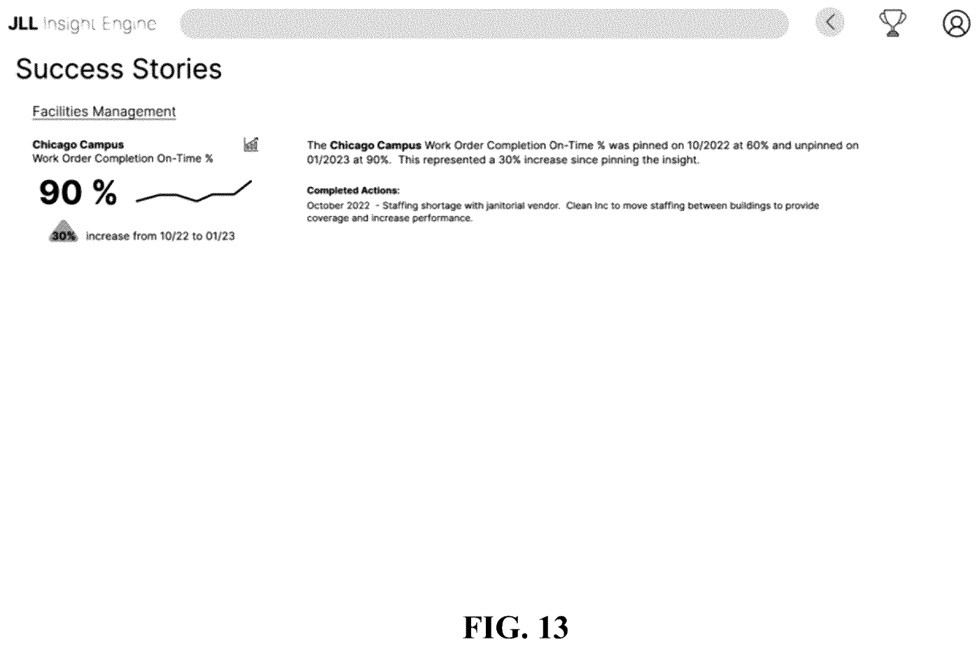

Recommended actions relating to the insight data can be generated (e.g., recommendation to move staffing between buildings as illustrated in FIG. 11). The analytics apparatus 14 can transmit the generated actionable items to the client computing device of the plurality of client computing devices 12(1)-12(n). In some examples, the analytics apparatus 14 can then receive implemented actions from the client computing device of the plurality of client computing devices 12(1)-12(n). After recommended actions are implemented or completed (as illustrated in FIG. 17), the analytics apparatus 14 can generate success stories as illustrated in FIG. 13.

In step 2025, the analytics apparatus 14 can output a new dashboard based on the generated set of insight data as a response to the data processing request as illustrated in FIG. 11 and the exemplary process can end at step 2030. The new dashboard can modify the interface to display the filtered manipulated data as illustrated in FIG. 11. In this example, FIG. 11 illustrates a percentage of work orders completed on time within the year for the Chicago Campus. The requesting one of the client computing devices 12(1)-12(n) would be able to access this new dashboard a year later to see the progress without having to repeat steps 2005-2020. In this example, the new dashboard is pinned or stored by the analytics apparatus 14 for future reference by the requesting one of the client computing devices 12(1)-12(n). The new dashboard can continue to track progress using the previously selected metrics, contextual data, and filters. The analytics apparatus 14 can, after another period of time can analyze the filtered manipulated data to generate a new set of insight data to track additional progress.

Having thus described the basic concept of the technology, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations, therefore, is not intended to limit the claimed processes to any order except as may be specified in the claims. Accordingly, the technology is limited only by the following claims and equivalents thereto.

What is claimed is:

1. A method comprising:
identifying, by a computing apparatus, one or more of a plurality of stored dashboards based on a selection from available metrics and contextual data in a received data processing request from a client device;
retrieving, by the computing apparatus, dashboard configuration data associated with the identified ones of the plurality of stored dashboards based on the selection from the available metrics and the contextual data;
generating, by the computing apparatus, manipulated data, from the dashboard configuration data based on the contextual data;
filtering, by the computing apparatus, the manipulated data based on one or more selected filters received from the client device, wherein the filtered manipulated data is analyzed to generate a set of insight data; and
outputting, by the computing apparatus, a new dashboard based on the generated set of insight data as a response to the data processing request.

2. The method as set forth in claim 1, wherein the manipulated data is generated based on: a time period trend, a predetermined threshold, a predetermined goal, historical usage data, or a predetermined contractual obligation.

3. The method as set forth in claim 2, wherein generating manipulated data based on the predetermined threshold further comprises:
retrieving benchmark data from a database; and
determining the predetermined threshold, wherein the predetermined threshold is received from the client device or generated based on benchmark data.

4. The method as set forth in claim 2, wherein generating the manipulated data based on the time period trend further comprising:
receiving a time period and interval from a client;
generating a graphical representation of the dashboard configuration data as the new dashboard; and
manipulating the graphical representation based on the time period and interval.

5. The method as set forth in claim 2, wherein generating the manipulated data based on the predetermined contractual obligation further comprises:
receiving contractual textual data from the client device; and
determining the predetermined contractual obligation based on the contractual textual data,
wherein the contractual textual data is generated by using optical character recognition to extract data from a received contract from the client device.

6. The method as set forth in claim 1, wherein the computing apparatus receives the one or more selected filters after sending a plurality of recommended filters, wherein the plurality of recommended filters is generated based on account information, and wherein the account information is preselected by a client or received prior to the generation of the plurality of recommended filters.

7. The method as set forth in claim 1, wherein the generated set of insight data comprises recommended actions, wherein the recommended actions are generated based on normalized historical actions from a database.

8. A non-transitory computer readable medium having stored thereon instructions comprising executable code, which when executed by at least one processor, cause the processor to:
identify, by a computing apparatus, one or more of a plurality of stored dashboards based on a selection from available metrics and contextual data in a received data processing request from a client device;
retrieve, by the computing apparatus, dashboard configuration data associated with the identified ones of the plurality of stored dashboards based on the selection from the available metrics and the contextual data;
generate, by the computing apparatus, manipulated data, from the dashboard configuration data based on the contextual data;
filter, by the computing apparatus, the manipulated data based on one or more selected filters received from the client device, wherein the filtered manipulated data is analyzed to generate a set of insight data; and
output, by the computing apparatus, a new dashboard based on the generated set of insight data as a response to the data processing request.

9. The medium as set forth in claim 8, wherein the manipulated data is generated based on: a time period trend, a predetermined threshold, a predetermined goal, historical usage data, or a predetermined contractual obligation.

10. The medium as set forth in claim 9, wherein generating manipulated data based on the predetermined threshold further comprises:
retrieving benchmark data from a database; and
determining the predetermined threshold, wherein the predetermined threshold is received from the client device or generated based on benchmark data.

11. The medium as set forth in claim 9, wherein generating the manipulated data based on the time period trend further comprising:
receiving a time period and interval from a client;
generating a graphical representation of the dashboard configuration data as the new dashboard; and
manipulating the graphical representation based on the time period and interval.

12. The medium as set forth in claim 8, wherein the computing apparatus receives the one or more selected filters after sending a plurality of recommended filters, wherein the plurality of recommended filters is generated based on account information, and wherein the account information is preselected by a client or received prior to the generation of the plurality of recommended filters.

13. The medium as set forth in claim 8, wherein the generated set of insight data comprises recommended actions, wherein the recommended actions are generated based on normalized historical actions from a database.

14. An analytics apparatus, comprising memory comprising programmed instructions stored in the memory and processors configured to be capable of executing the programmed instructions stored in the memory to:
identify, by a computing apparatus, one or more of a plurality of stored dashboards based on a selection from available metrics and contextual data in a received data processing request from a client device;
retrieve, by the computing apparatus, dashboard configuration data associated with the identified ones of the plurality of stored dashboards based on the selection from the available metrics and the contextual data;
generate, by the computing apparatus, manipulated data, from the dashboard configuration data based on the contextual data;
filter, by the computing apparatus, the manipulated data based on one or more selected filters received from the client device, wherein the filtered manipulated data is analyzed to generate a set of insight data; and
output, by the computing apparatus, a new dashboard based on the generated set of insight data as a response to the data processing request.

15. The analytics apparatus as set forth in claim 14, wherein the manipulated data is generated based on: a time period trend, a predetermined threshold, a predetermined goal, historical usage data, or a predetermined contractual obligation.

16. The analytics apparatus as set forth in claim 15, wherein generating the manipulated data based on the time period trend further comprising:
receiving a time period and interval from a client;
generating a graphical representation of the dashboard configuration data as the new dashboard; and
manipulating the graphical representation based on the time period and interval.

17. The analytics apparatus as set forth in claim 15, wherein the processors are further configured to be capable of executing the programmed instructions stored in the memory to:
receive contractual textual data from the client device; and
determine the predetermined contractual obligation based on the contractual textual data,
wherein the contractual textual data is generated by using optical character recognition to extract data from a received contract from the client device.

18. The analytics apparatus as set forth in claim 15, wherein generating manipulated data based on the predetermined threshold further comprises:
retrieving benchmark data from a database; and
determining the predetermined threshold, wherein the predetermined threshold is received from the client device or generated based on benchmark data.

19. The analytics apparatus as set forth in claim 14, wherein the computing apparatus receives the one or more selected filters after sending a plurality of recommended filters, wherein the plurality of recommended filters is generated based on account information, and wherein the account information is preselected by a client or received prior to the generation of the plurality of recommended filters.

20. The analytics apparatus as set forth in claim 14, wherein the generated set of insight data comprises recommended actions, wherein the recommended actions are generated based on normalized historical actions from a database.
